(19) United States
(12) Patent Application Publication
(10) Pub. No.: US 2014/0344687 A1
(43) Pub. Date: Nov. 20, 2014

(54) Techniques for Natural User Interface Input based on Context

(71) Applicants: Lenitra Durham, Beaverton, OR (US); Glen Anderson, Beaverton, OR (US); Philip Muse, Folsom, CA (US)

(72) Inventors: Lenitra Durham, Beaverton, OR (US); Glen Anderson, Beaverton, OR (US); Philip Muse, Folsom, CA (US)

(21) Appl. No.: 13/997,217

(22) PCT Filed: May 16, 2013
(86) PCT No.: PCT/US2013/041404

§ 371 Date: Jun. 22, 2013

(51) Int. Cl. G06F 3/0484

(52) U.S. Cl. CPC G06F 3/04842
USPC 715/716

(57) ABSTRACT

Examples are disclosed for interpreting a natural user interface (UI) input event. In some examples, sensor information may be received during a command for an application. The command input may be interpreted as a natural UI input event. For some examples, context information related to the command input may cause a context to be associated with the natural UI input event. The context may then cause a change to how media content may be retrieved for the application. Other examples are described and claimed.

### TECHNICAL FIELD

Examples described herein are generally related to interpretation of a natural user interface input to a device.

### BACKGROUND

Computing devices such as, for example, laptops, tablets or smart phones may utilize sensors for detecting a natural user interface (UI) input. The sensors may be embedded and/or coupled to the computing devices. In some examples, a given natural UI input event may be detected based on information gathered or obtained by these types of embedded and/or coupled sensors. For example, the detected given natural UI input may be an input command (e.g., a user gesture) that may indicate an intent of the user to affect an application executing on a computing device. The input command may include the user physically touching a sensor (e.g., a haptic sensor), making a gesture in an air space near another sensor (e.g., an image sensor), purposeful movement of at least a portion of the computing device by the user detected by yet another sensor (e.g., a motion sensor) or an audio command detected still other sensors (e.g., a microphone).

### BRIEF DESCRIPTION OF THE DRAWINGS

FIG. 1 illustrates an example of front and back views of a first device.

FIGS. 2A-B illustrate example first contexts for interpreting a natural user interface input event.

FIGS. 3A-B illustrate example second contexts for natural UI input based on context.

FIG. 4 illustrates an example architecture for interpreting a natural user interface input.

FIG. 5 illustrates an example mapping table.

FIG. 6 illustrates an example block diagram for an apparatus.

FIG. 7 illustrates an example of a logic flow.

FIG. 8 illustrates an example of a storage medium.

FIG. 9 illustrates an example of a second device.

### DETAILED DESCRIPTION

Examples are generally directed to improvements for interpreting detected input commands to possibly affect an application executing on a computing device (hereinafter referred to as a device). As contemplated in this disclosure, input commands may include touch gestures, air gestures, device gestures, audio commands, pattern recognitions or object recognitions. In some examples, an input command may be interpreted as a natural UI input event to affect the application executing on the device. For example, the application may include a messaging application and the interpreted natural UI input event may cause either predetermined text or media content to be added to a message being created by the messaging application.

In some examples, predetermined text or media content may be added to the message being created by the messaging application regardless of a user's context. Adding the text or media content to the message regardless of the user's context may be problematic, for example, when recipients of the message vary in levels of formality. Each level of formality may represent different contexts. For example, responsive to the interpreted natural UI input event, a predetermined media content may be a beer glass icon to indicate “take a break?”. The predetermined media content of the beer glass icon may be appropriate for a defined relationship context such as a friend/co-worker recipient context but may not be appropriate for another type of defined relationship context such as a work supervisor recipient context.

In some other examples, the user's context may be based on the actual physical activity the user may be performing. For these examples, the user may be running or jogging and an interpreted natural UI input event may affect a music player application executing on the device. For example, a command input such as a device gesture that includes shaking the device may cause the music player application to shuffle music selections. This may be problematic when running or jogging as the movement of the user may cause the music selection to be inadvertently shuffled and thus degrade the user experience of enjoying uninterrupted music.

In some examples, techniques are implemented for natural UI input to an application executing on a device based on context. These techniques may include detecting, at the device, a first input command. The first input command may be interpreted as a first natural UI input event. The first natural UI input event may then be associated with a context based on context information related to the command input. For these examples, a determination as to whether to process the first natural UI input event based on the context may be made. For some examples, the first natural UI input event may be processed based on the context. The processing of the first natural UI input may include determining whether the context causes a switch from a first media retrieval mode to a second media retrieval mode. Media content may then be retrieved for an application based on the first or the second media retrieval mode.

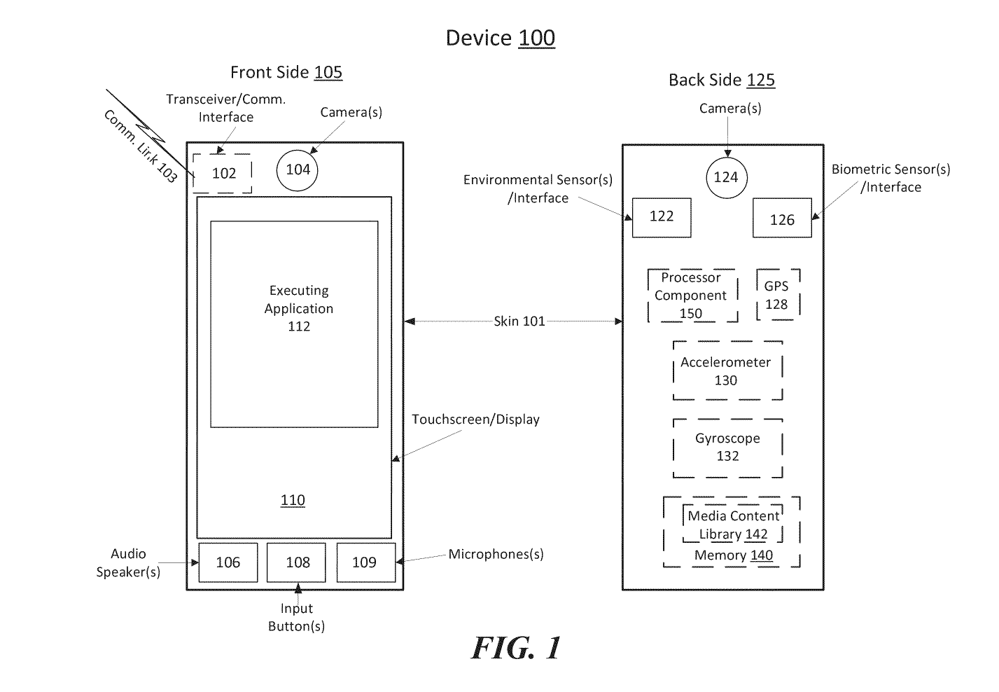

FIG. 1 illustrates an example of front and back views of a first device 100. In some examples, device 100 has a front side 105 and a back side 125 as shown in FIG. 1. For these examples, front side 105 may correspond to a side of device 100 that includes a touchscreen/display 110 that provides a view of executing application 112 to a user of device 100. Meanwhile, back side 125 may be the opposite/back side of device 100 from the display view side. Although, in some examples, a display may also exist on back side 125, for ease of explanation, FIG. 1 does not include a back side display.

According to some examples, front side 105 includes elements/features that may be at least partially visible to a user when viewing device 100 from front side 105 (e.g., visible through or on the surface of skin 101). Also, some elements/features may not be visible to the user when viewing device 100 from front side 105. For these examples, solid-lined boxes may represent those features that may be at least partially visible and dashed-line boxes may represent those element/features that may not be visible to the user. For example, transceiver/communication (comm.) interface 102 may not be visible to the user, yet at least a portion of camera(s) 104, audio speaker(s) 106, input button(s) 108, microphone(s) 109 or touchscreen/display 110 may be visible to the user.

In some examples, back side 125 includes elements/features that may be at least partially visible to a user when viewing device 100 from back side 125. Also, some elements/features may not be visible to the user when viewing device 100 from back side 125. For these examples, solid-lined boxes may represent those features that may be at least partially visible and dashed-line boxes may represent those element/features that may not be visible. For example, global positioning system (GPS) 128, accelerometer 130, gyroscope 132, memory 140 or processor component 150 may not be visible to the user, yet at least a portion of environmental sensor(s) 122, camera(s) 124 and biometric sensor(s)/interface 126 may be visible to the user.

According to some examples, as shown in FIG. 1, a comm. link 101 may wirelessly couple device 100 via transceiver/comm. interface 102. For these examples, transceiver/comm. interface 102 may be configured and/or capable of operating in compliance with one or more wireless communication standards to establish a network connection with a network (not shown) via comm. link 103. The network connection may enable device 100 to receive/transmit data and/or enable voice communications through the network.

In some examples, various elements/features of device 100 may capable of providing sensor information associated with detected input commands (e.g., user gestures or audio command) to logic, features or modules for execution by processor component 150. For example, touch screen/display 110 may detect touch gestures. Camera(s) 104 or 124 may detect spatial/air gestures or pattern/object recognition. Accelerometer 130 and/or gyroscope 132 may detect device gestures. Microphone(s) 109 may detect audio commands. As described more below, the provided sensor information may indicate to the modules to be executed by processor component 150 that the detected input command may be to affect executing application 112 and may interpret the detected input command as a natural UI input event.

In some other examples, a series or combination of detected input commands may indicate to the modules for execution by processor component 150 that a user has intent to affect executing application 112 and then interpret the detected series of input commands as a natural UI input event. For example, a first detected input command may be to activate microphone 109 and a second detected input command may be a user-generated verbal or audio command detected by microphone 109. For this example, the natural UI input event may then be interpreted based on the user-generated verbal or audio command detected by microphone 109. In other examples, a first detected input command may be to activate a camera from among camera(s) 104 or 124. For these other examples, the natural UI input event may then be interpreted based on an object or pattern recognition detected by the camera (e.g., via facial recognition, etc.).

In some examples, various elements/features of device 100 may be capable of providing sensor information related to a detected input command. Context information related to the input command may include sensor information gathered by/through one or more of environmental sensor(s)/interface 122 or biometric sensor(s)/interface 126. Context information related to the input command may also include, but is not limited to, sensor information gathered by one or more of camera(s) 104/124, microphones 109, GPS 128, accelerometer 130 or gyroscope 132.

According to some examples, context information related to the input command may include one or more of a time of day, GPS information received from GPS 128, device orientation information received from gyroscope 132, device rate of movement information received from accelerometer 130, image or object recognition information received from camera(s) 104/124. In some examples, time, GPS, device orientation, device rate of movement or image/object recognition information may be received by modules for execution by processor component 150 and then a context may be associated with a natural UI input event interpreted from a detected input command. In other words, the above-mentioned time, location, orientation, movement or image recognition information may be used by the modules to determine a context in which the input command is occurring and then associate that context with the natural UI input event.

In some examples, context information related to the input command may also include user inputted information that may indicate a type of user activity. For example, a user may manually input the type of user activity using input button(s) 108 or using natural UI inputs via touch/air/device gestures or audio commands to indicate the type of user activity. The type of user activity may include, but is not limited to, exercise activity, work place activity, home activity or public activity. In some examples, the type of user activity may be used by modules for execution by processor component 150 to associate a context with a natural UI input event interpreted from a detected input command. In other words, the type of user activity may be used by the modules to determine a context in which the input command is occurring and then associate that context with the natural UI input event.

According to some examples, sensor information gathered by/through environmental sensor(s)/interface 122 may include ambient environmental sensor information at or near device 100 during the detected input. Ambient environmental information may include, but is not limited to, noise levels, air temperature, light intensity or barometric pressure. In some examples, ambient environmental sensor information may be received by modules for execution by processor component 150 and then a context may be associated with a natural UI input event interpreted from a detected input command. In other words, ambient environmental information may be used by the modules to determine a context in which the input command is occurring and then associate that context with the natural UI input event.

In some examples, the context determined based on ambient environmental information may indicate types of user activities. For example, ambient environmental information that indicates a high altitude, cool temperature, high light intensity and frequent changes of location may indicate that the user is involved in an outdoor activity that may include bike riding, mountain climbing, hiking, skiing or running. In other examples, ambient environmental information that indicates, mild temperatures, medium light intensity, less frequent changes of location and moderate ambient noise levels may indicate that the user is involved in a workplace or home activity. In yet other examples, ambient environmental information that indicates mild temperatures, medium or low light intensity, some changes in location and high ambient noise levels may indicate that the user is involved in a public activity and is in a public location such as a shopping mall or along a public walkway or street.

According to some examples, sensor information gathered by/through biometric sensor(s)/interface 126 may include biometric information associated with a user of device 100 during the input command. Biometric information may include, but is not limited to, the user's heart rate, breathing rate or body temperature. In some examples, biometric sensor information may be received by modules for execution by processor component 150 and then a context may be associated with a natural UI input event interpreted from a detected input command. In other words, biometric information for the user may be used by the modules to determine a context via which the input command is occurring and then associate that context with the natural UI input event.

In some examples, the context determined based on user biometric information may indicate types of user activities. For example, high heart rate, breathing rate and body temperature may indicate some sort of physically strenuous user activity (e.g., running, biking, hiking, skiing, etc.). Also, relatively low or stable heart rate/breathing rate and a normal body temperature may indicate non strenuous user activity (e.g., at home or at work). The user biometric information may be used with ambient environmental information to enable modules to determine the context via which the input command is occurring. For example, environmental information indicating high elevation combined with biometric information indicating a high heart rate may indicate hiking or climbing. Alternatively environmental information indicating a low elevation combined with biometric information indicating a high heart rate may indicate bike riding or running.

According to some examples, a type of application for executing application 112 may also provide information related to a detected input command. For these examples, a context may be associated with a natural UI input event interpreted from a detected input command based, at least in part, on the type of application. For example, the type of application may include, but is not limited to, a text messaging application, a video chat application, an e-mail application, a video player application, a game application, a work productivity application, an image capture application, a web browser application, a social media application or a music player application.

In some examples, the type of application for executing application 112 may include one of a text messaging application, a video chat application, an e-mail application or a social media application. For these examples, context information related to the detected input command may also include an identity of a recipient of a message generated by the type of application responsive to the natural UI input event interpreted from the input command. The identity of the recipient of the message, for example, may be associated with a profile having identity and relationship information that may define a relationship of the user to the recipient. The defined relationship may include one of a co-worker of a user of device 100, a work supervisor of the user, a parent of the user, a sibling of the user or a professional associate of the user. Modules for execution by processor component 150 may use the identity of the recipient of the message to associate the natural UI input event with a context.

According to some examples, modules for execution by processor component 150 may determine whether to further process a given natural UI input event based on a context associated with the given natural UI input according to the various types of context information received as mentioned above. If further processing is determined, as described more below, a media selection mode may be selected to retrieve media content for executing application 112 responsive to the given natural UI input event. Also, modules for execution by processor component 150 may determine whether to switch a media selection mode from a first media retrieval mode to a second media retrieval mode. Media content for executing application 112 may then be retrieved by the modules responsive to the natural UI input event based on the first or second media retrieval modes.

According to some examples, as described in more detail below, media selection modes may be based on media mapping that maps media content to a given natural UI input event when associated with a given context. In some examples, the media content may be maintained in a media content library 142 stored in non-volatile and/or volatile types of memory included as part of memory 140. In some examples, media content may be maintained in a network accessible media content library maintained remote to device 100 (e.g. accessible via comm. link 103). In some examples, the media content may be user-generated media content generated at least somewhat contemporaneously with a given user activity occurring when the given natural UI input event was interpreted. For example, an image or video captured using camera(s) 104/124 may result in user-generated images or video that may be mapped to the given natural UI input event when associated with the given context.

In some examples, one or more modules for execution by processor component 150 may be capable of causing device 100 to indicate which media retrieval mode for retrieving media content has been selected based on the context associated with the given natural UI input event. Device 100 may indicate the selected media retrieval mode via at least one of an audio indication, a visual indication or a vibrating indication. The audio indication may be a series of audio beeps or an audio statement of the selected media retrieval mode transmitted through audio speaker(s) 106. The visual indication may be indications displayed on touchscreen/display 110 or displayed via light emitting diodes (not shown) that may provide color-based or pattern-based indications of the selected media retrieval mode. The vibrating indication may be a pattern of vibrations of device 100 caused by a vibrating component (not shown) that may be capable of being felt or observed by a user.

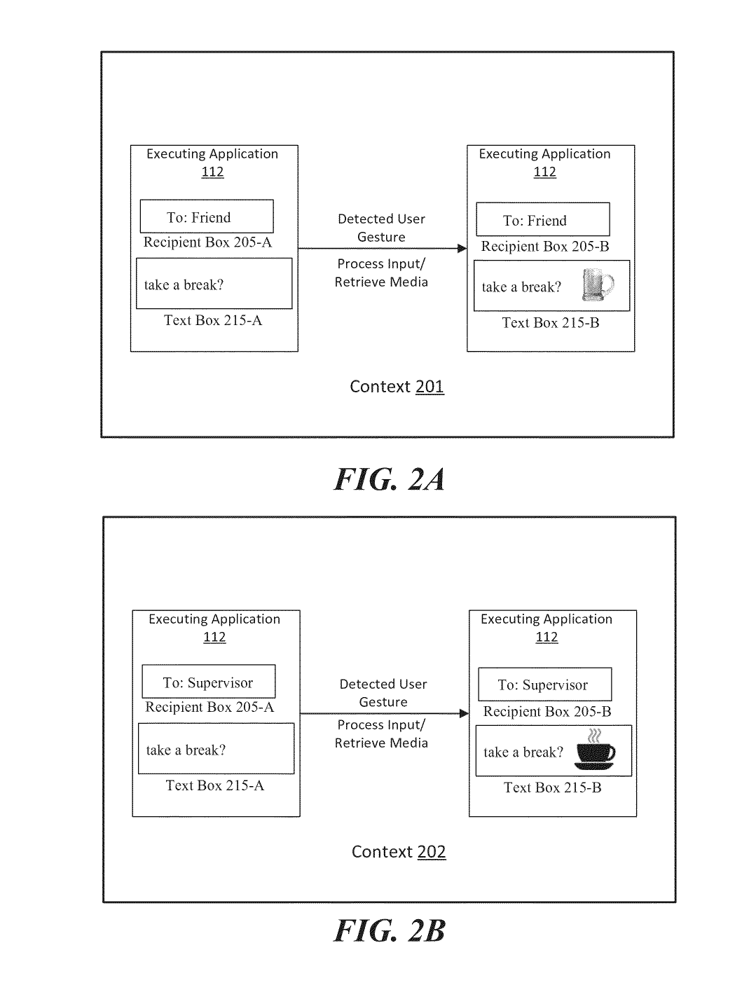

FIGS. 2A-B illustrate example first contexts for interpreting a natural UI input event. According to some examples, as shown in FIGS. 2A and 2B, the example first contexts include context 201 and context 202, respectively. For these examples, FIGS. 2A and 2B each depict user views of executing application 112 from device 100 as described above for FIG. 1. The user views of executing application 112 depicted in FIGS. 2A and 2B may be for a text messaging type of application. As shown in FIGS. 2A and 2B, executing application 112 may have a recipient box 205-A and a text box 215-A for a first view (left side) and a recipient box 205-B and a text box 215-B for a second view (right side).

According to some examples, as shown in FIG. 2A, recipient box 205-A may indicate that a recipient of a text message is a friend. For these examples, an input command may be detected based on received sensor information as mentioned above for FIG. 1. The input command for this example may be to create a text message to send to a recipient indicated in recipient box 205-A.

In some examples, the input command may be interpreted as a natural UI input event based on the received sensor information that detected the input command. For example, a touch, air or device gesture by the user may be interpreted as a natural UI input event to affect executing application 112 by causing the text “take a break?” to be entered in text box 215-A.

In some examples, the natural UI input event to cause the text “take a break?” may be associated with a context 201 based on context information related to the input command. For these examples, the context information related to the user activity may be merely that the recipient of the text message is a friend of the user. Thus, context 201 may be described as a context based on a define relationship of a friend of the user being the recipient of the text message “take a break?” and context 201 may be associated with the natural UI input event that created the text message included in text box 215-A shown in FIG. 2A. In other examples, additional context information such as environmental/biometric sensor information may also be used to determine and describe a more detailed context 201.

According to some examples, a determination may be made as to whether to process the natural UI input event that created the text message based on context 201. For these examples, to process the natural UI input event may include determining what media content to retrieve and add to the text message created by the natural UI input event. Also, for these examples, the determination may depend on whether media content has been mapped to the natural UI input event when associated with context 201. Media content may include, but is not limited to, an emoticon, an animation, a video, a music selection, a voice/audio recording a sound effect or an image. According to some examples, if media content has been mapped, then a determination may be made as to what media content to retrieve. Otherwise, the text message “take a break?” may be sent without retrieving and adding media content, e.g., no further processing.

In some examples, if the natural UI input event that created “take a break?” is to be processed, a determination may then be made as to whether context 201 (e.g., the friend context) causes a switch from a first media retrieval mode to a second media retrieval mode. For these examples, the first media retrieval mode may be based on a first media mapping that maps first media content to the natural UI input event when associated with context 201 and the second media retrieval mode may be based on a second mapping that maps second media content to the natural UI input event when associated with context 202. According to some examples, the first media content may be an image of a beer mug as shown in text box 215-B. For these examples, the beer mug image may be retrieved based on the first media mapping that maps the beer mug to the natural UI input event that created “take a break?” when associated with context 201. Since the first media retrieval mode is based on the first media mapping no switch in media retrieval modes is needed for this example. Hence, the beer mug image may be retrieved (e.g., from media content library 142) and added to the text message as shown for text box 215-B in FIG. 2A. The text message may then be sent to the friend recipient.

According to some examples, as shown in FIG. 2B, recipient box 205-A may indicate that a recipient of a text message is a supervisor. For these examples, the user activity for this example may be creating a text message to send to a recipient indicated in recipient box 205-A. Also, for these examples, the information related to the user activity may be that the recipient of the text message as shown in recipient box 205-A is has a defined relationship with the user of a supervisor.

In some examples, the natural UI input event to cause the text “take a break?” may be associated with a given context based on the identity of the recipient of the text message as a supervisor of the user. Thus, context 202 may be described as a context based on a defined relationship of a supervisor of the user being the identified recipient of the text message “take a break?” and context 202 may be associated with the natural UI input event that created the text message included in text box 215-A shown in FIG. 2B.

According to some examples, a determination may be made as to whether to process the natural UI input event that created the text message based on context 202. Similar to what was mentioned above for context 201, the determination may depend on whether media content has been mapped to the natural UI input event when associated with context 202. According to some examples, if media content has been mapped then a determination may be made as to what media content to retrieve. Otherwise, the text message “take a break?” may be sent without retrieving and adding media content, e.g., no further processing.

In some examples, if the natural UI input event that created “take a break?” is to be processed, a determination may then be made as to whether context 202 (e.g., the supervisor context) causes a switch from a first media retrieval mode to a second media retrieval mode. As mentioned above, the first media retrieval mode may be based on a first media mapping that maps first media content to the natural UI input event when associated with context 201 and the second media retrieval may be based on a second mapping that maps second media content to the natural UI input event when associated with context 202. Also as mentioned above, the first media content may be an image of a beer mug. However, an image of a beer mug may not be appropriate to send to a supervisor. Thus, the natural UI input event when associated with context 202 would not map to the first mapping that maps to a beer mug image. Rather, according to some examples, the first media retrieval mode is switched to the second media retrieval mode that is based on the second media mapping to the second media content. The second media content may include a possibly more appropriate image of a coffee cup. Hence, the coffee cup image may be retrieved (e.g., from media content library 142) and added to the text message as shown for text box 215-B in FIG. 2A. The text message may then be sent to the supervisor recipient.

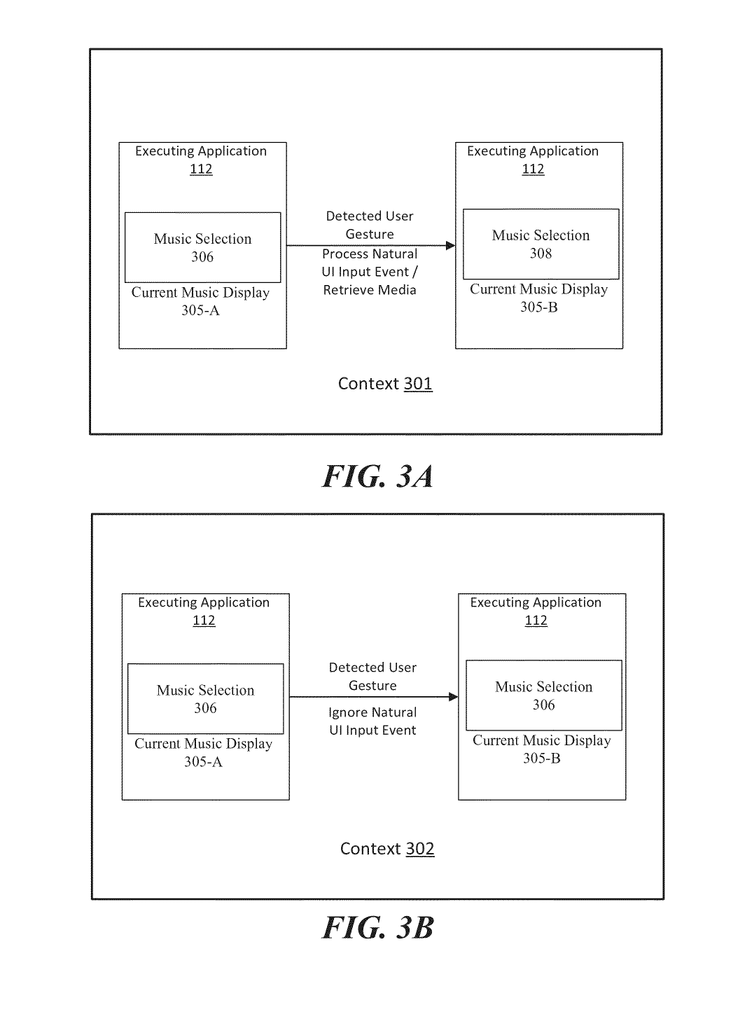

FIGS. 3A-B illustrate example second contexts for interpreting a natural UI input event. According to some examples, as shown in FIGS. 3A and 3B the example second contexts include context 301 and context 302, respectively. For these examples, FIGS. 3A and 3B each depict user views of executing application 112 from device 100 as described above for FIG. 1. The user views of executing application 112 depicted in FIGS. 3A and 3B may be for a music player type of application. As shown in FIGS. 3A and 3B, executing application 112 may have a current music display 305A for a first view (left side) and a current music display 305B for a second view (right side).

According to some examples, as shown in FIG. 3A, current music display 305-A may indicate a current music selection being played by executing application 112 and music selection 306 may indicate that current music selection. For these examples, an input command may be detected based on received sensor information as mentioned above for FIG. 1. For this example, the user may be listening to a given music selection.

In some examples, the input command may be interpreted as a natural UI event based on the received sensor information that detected the input command. For example, a device gesture by the user that includes shaking or quickly moving the device in multiple directions may be interpreted as a natural UI input event to affect executing application 112 by attempting to cause the music selection to change from music selection 306 to music selection 308 (e.g., via a shuffle or skip music selection input).

In some examples, the natural UI input event to cause a change in the music selection may be associated with context 301 based on context information related to the input command. For these examples, context 301 may include, but is not limited to, one or more of the device located in a high ambient noise environment, the device located in a public location, the device located in a private or home location, the device located in a work or office location or the device remaining in a relatively static location.

According to some examples, context information related to the input command made while the user listens to music may include context information such as time, location, movement, position, image/pattern recognition or environmental and/or biometric sensor information that may be used to associate context 301 with the natural UI input event. For these examples, the context information related to the input command may indicate that the user is maintaining a relatively static location, with low amounts of movement, during a time of day that is outside of regular work hours (e.g., after 5 pm). Context 301 may be associated with the natural UI input event based on this context information related to the user activity as the context information indicates a shaking or rapid movement of the device may be a purposeful device gesture and not a result of inadvertent movement.

In some examples, as a result of the natural UI input event being associated with context 301, the natural UI input event may be processed. For these examples, processing the natural UI input event may include determining whether context 301 causes a shift from a first media retrieval mode to a second media retrieval mode. For these examples, the first media retrieval mode may be based on a media mapping that maps first media content to the natural UI input event when associated with context 301 and the second media retrieval mode may be based on ignoring the natural UI input event. According to some examples, the first media content may be music selection 308 as shown in current music display 305-B for FIG. 3A. For these examples, music selection 308 may be retrieved based on the first media retrieval mode and the given music selection being played by executing application 112 may be changed from music selection 306 to music selection 308.

According to some examples, as shown in FIG. 3B for context 302, a detected input command interpreted as a user UI input event may be ignored. For these examples, the input command may be detected based on received sensor information as mentioned above for FIG. 1 and FIG. 3A. Also, similar to FIG. 3A, the user may be listening to a given music selection and the interpreted user UI input event may be an attempt to cause a change in music selection 306 to another given music selection.

In some examples, the natural UI input event to cause a change in the given music selection may be associated with context 302 based on context information related to the input command. For these examples, context 302 may include, but is not limited to, one or more of the user running or jogging with the device, a user bike riding with the device, a user walking with the device or a user mountain climbing or hiking with the device.

According to some examples, context information related to the input command made while the user listens to music may include context information such as time, location, movement, position, image/pattern recognition or environmental and/or biometric sensor information that may be used to associate context 302 with the natural UI input event. For these examples, the context information related the input command may include information to indicate that the device is changing location on a relatively frequent basis, device movement and position information is fluctuating or biometric information for the user indicates an elevated or substantially above normal heart rate and/or body temperature. Context 302 may be associated with the natural UI input event based on this context information related to the user activity as the information indicates a shaking or rapid movement of the device may be an unintended or inadvertent movement.

In some examples, as a result of the natural UI input event being associated with context 302, the natural UI input event is not further processed. As shown in FIG. 3B, the natural UI input event is ignored and music selection 306 remains unchanged as depicted in current music display 305-B.

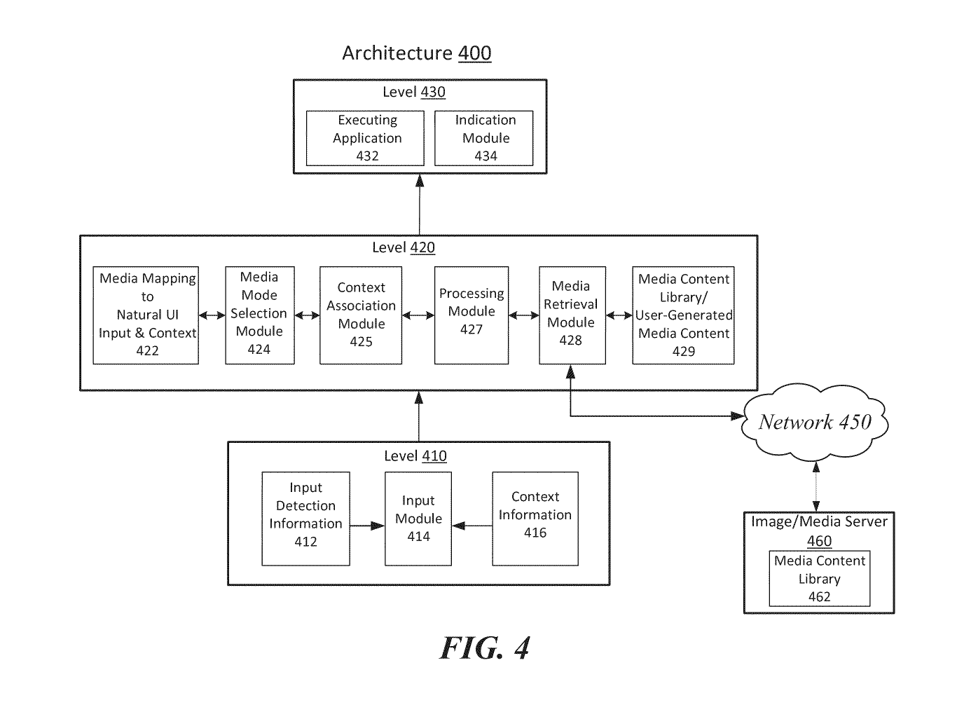

FIG. 4 illustrates an example architecture for natural UI input based on context. According to some examples, as shown in FIG. 4, example architecture 400 includes a level 410, a level 420 and a level 430. Also, as shown in FIG. 4, level 420 includes a module coupled to network 450 via a comm. link 440 to possibly access an image/media server 460 having or hosting a media content library 462.

In some examples, levels 410, 420 and 430 may be levels of architecture 400 carried out or implemented by modules executed by a processor component of a device such as device 100 described for FIG. 1. For some examples, at level 410, input module 414 may be executed by the processor component to receive sensor or input detection information 412 that indicates an input command to affect executing application 432 executing on the device. Gesture module 414 may interpret the detected command input as a natural UI input event. Input module 414, although not shown in FIG. 4, may also include various context building blocks that may use context information (e.g., sensor information) and middleware to allow detected input commands such as a user gesture to be understood or detected as purposeful input commands to a device.

According to some examples, at level 420, context association module 425 may be executed by the processor component to associate the natural UI input event interpreted by input module 414 with a first context. For these examples, the first context may be based on context information 416 that may have been gathered during detection of the input command as mentioned above for FIG. 1, 2A-B or 3A-B.

In some examples, at level 420, media mode selection module 424 may be executed by the processor component to determine whether the first context causes a switch from a first media retrieval mode to a second media retrieval mode. For these examples, media mapping to natural UI input & context 422 may also be used to determine whether to switch media retrieval modes. Media retrieval module 428 may be executed by the processor component to retrieve media from media content library/user-generated media content 429 based on the first or the second media retrieval mode.

In some examples, the first media retrieval mode may be based on a first media mapping that maps first media content (e.g., a beer mug image) to the natural UI input event when associated with the first context. For these examples, media retrieval module 428 may retrieve the first media content either from media content library/user-generated content 429 or alternatively may utilize comm. link 140 to retrieve the first media content from media content library 462 maintained at or by image/media server 460. Media retrieval module 428 may then provide the first media content to executing application 432 at level 430.

According to some examples, the second media retrieval mode may be based on a second media mapping that maps second media content (e.g., a coffee cup image) to the natural input event when associated with the first context. For these examples, media retrieval module 428 may also retrieve the second media content from either media content library/user-generated content 429 or retrieve the first media content from media content library 462. Media retrieval module 428 may then provide the second media content to executing application 432 at level 430.

According to some examples, processing module 427 for execution by the processor component may prevent media retrieval module 428 from retrieving media for executing application 432 based on the natural UI input event associated with the first context that may include various type of user activities or device locations via which the natural UI input event should be ignored. For example, as mentioned above for FIGS. 3A-B, a rapid shaking user gesture that may be interpreted to be a natural UI input event to shuffle a music selection should be ignored when a user is running or jogging, walking, bike riding, mountain climbing, hiking or performing other types of activities causing frequent movement or changes in location. Other types of input commands such as audio commands may be improperly interpreted in high ambient noise environments. Air gestures, object recognition or pattern recognition input commands may be improperly interpreted in high ambient light levels or public places having a large amount of visual clutter and peripheral movement at or near the user. Also, touch gesture input commands may not be desired in extremely cold temperatures due to the protective hand coverings or cold fingers degrading a touch screen's accuracy. These are but a few examples, this disclosure is not limited to only the above mentioned examples.

In some examples, an indication module 434 at level 430 may be executed by the processor component to indicate either the first media retrieval mode or the second media retrieval mode for retrieving the media. For these examples, indication module 434 may cause the device to indicate a given media retrieval mode via at least one of an audio indication, a visual indication or a vibrating indication.

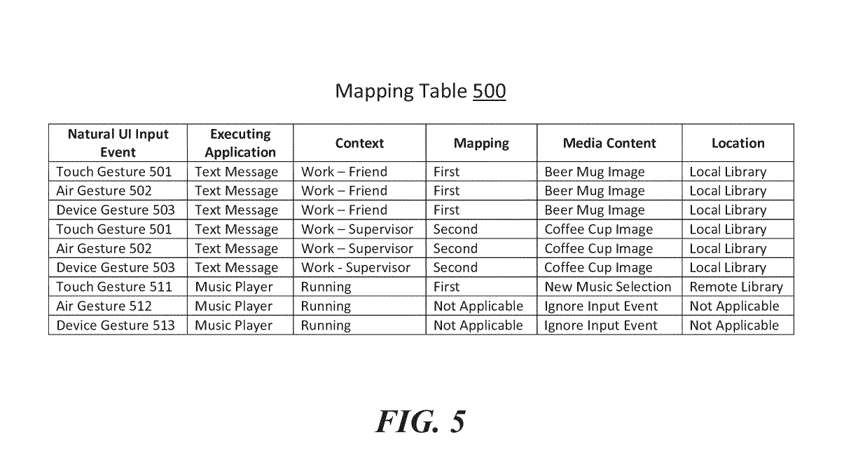

FIG. 5 illustrates an example mapping table 500. In some examples, as shown in FIG. 5, mapping table 500 maps given natural UI input events to given media content when associated with a given context. In some examples, mapping table 500 may be maintained at a device such as device 100 (e.g., in a data structure such as lookup table (LUT)) and may be utilized by modules executed by a processor component for the device. The modules (e.g., such as media mode selection module 424 and/or media retrieval module 428) may utilize mapping table 500 to select a media retrieval mode based on an associated context and to determine where or whether to retrieve media content based on the associated context.

Also, for these examples, mapping table 500 may indicate a location for the media content. For example, beer mug or coffee cup images may be obtained from a local library maintained at a device via which a text message application may be executing on. In another example, a new music selection may be obtained from a remote or network accessible library that is remote to a device via which a music player application may be executing on. In yet another example, a local library location for the media content may include user-generated media content that may have been generated contemporaneously with the user activity (e.g., an image capture of an actual beer mug or coffee cup) or with a detected input command.

Mapping table 500 includes just some examples of natural UI input events, executing applications, contexts, media content or locations. This disclosure is not limited to these examples and other types of natural UI input events, executing applications, contexts, media content or locations are contemplated.

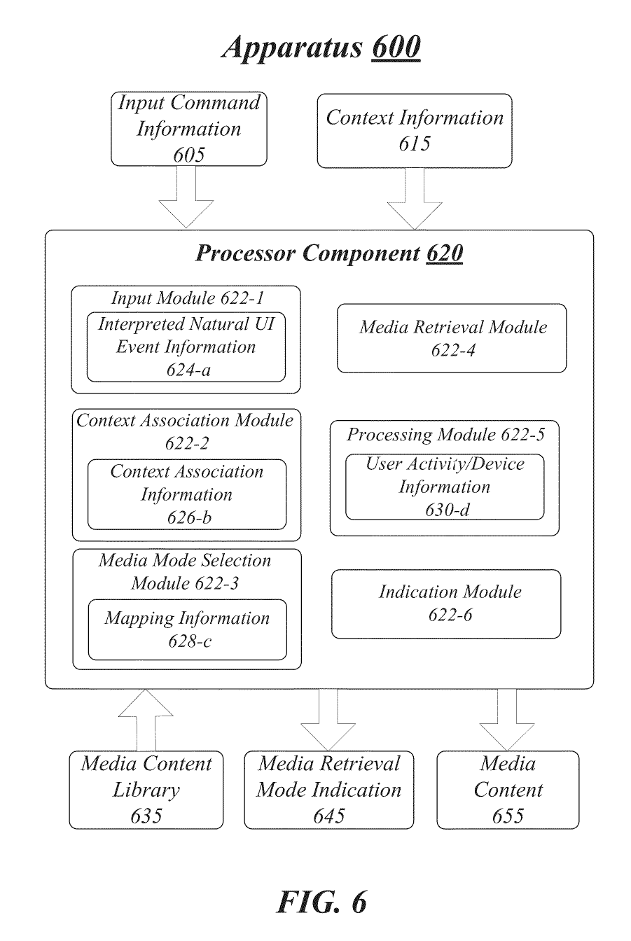

FIG. 6 illustrates an example block diagram for an apparatus 600. Although apparatus 600 shown in FIG. 6 has a limited number of elements in a certain topology or configuration, it may be appreciated that apparatus 600 may include more or less elements in alternate configurations as desired for a given implementation.

The apparatus 600 may comprise a computer-implemented apparatus 600 having a processor component 620 arranged to execute one or more software modules 622-a. It is worthy to note that “a” and “b” and “c” and similar designators as used herein are intended to be variables representing any positive integer. Thus, for example, if an implementation sets a value for a=6, then a complete set of software modules 622-a may include modules 622-1, 622-2, 622-3, 622-4 and 622-5. The embodiments are not limited in this context.

According to some examples, apparatus 600 may be part of a computing device or device similar to device 100 described above for FIGS. 1-5. The examples are not limited in this context.

In some examples, as shown in FIG. 6, apparatus 600 includes processor component 620. Processor component 620 may be generally arranged to execute one or more software modules 622-a. The processor component 620 can be any of various commercially available processors, such as embedded and secure processors, dual microprocessors, multi-core processors or other multi-processor architectures. According to some examples processor component 620 may also be an application specific integrated circuit (ASIC) and at least some modules 622-a may be implemented as hardware elements of the ASIC.

According to some examples, apparatus 600 may include an input module 622-1. Input module 622-1 may be executed by processor component 620 to receive sensor information that indicates an input command to a device that may include apparatus 600. For these examples, interpreted natural UI event information 624-a may be information at least temporarily maintained by input module 622-1 (e.g., in a data structure such as LUT). In some examples, interpreted natural UI event information 624-a may be used by input module 622-1 to interpret the input command as a natural UI input event based on input command information 605 that may include the received sensor information.

In some examples, apparatus 600 may also include a context association module 622-2. Context association module 622-2 may be executed by processor component 620 to associate the natural UI input event with a given context based on context information related to the input command. For these examples, context information 615 may be received by context association module 622-2 and may include the context information related to the input command. Context association module 622-2 may at least temporarily maintain the context information related to the given user activity as context association information 626-b (e.g., in a LUT).

In some examples, apparatus 600 may also include a media mode selection module 622-3. Media mode selection module 622-3 may be executed by processor component 620 to determine whether the given context causes a switch from a first media retrieval mode to a second media retrieval mode. For these examples, mapping information 628-c may be information (e.g., similar to mapping table 500) that maps media content to the natural UI input event when associated with the given context. Mapping information 628-c may be at least temporarily maintained by media mode selection module 622-3 (e.g. in an LUT) and may also include information such as media library locations for mapped media content (e.g., local or network accessible).

According to some examples, apparatus 600 may also include a media retrieval module 622-4. Media retrieval module 622-4 may be executed by processor component 620 to retrieve media content 655 for the application executing on the device that may include apparatus 600. For these examples, media content 655 may be retrieved from media content library 635 responsive to the natural UI input based on which of the first or second media retrieval modes were selected by media mode selection module 622-3. Media content library 635 may be either a local media content library or a network accessible media content library. Alternatively, media content 655 may be retrieved from user-generated media content that may have been generated contemporaneously with the input command and at least temporarily stored locally.

In some examples, apparatus 600 may also include a processing module 622-5. Processing module 622-5 may be executed by processor component 620 to prevent media retrieval module 622-4 from retrieving media content for the application based on the natural UI input event associated with the given context that includes various user activities or device situations. For these examples, user activity/device information 630-d may be information for the given context that indicates various user activities or device situations that may cause processing module 622-5 to prevent media retrieval. User activity/device information may be at least temporarily maintained by processing module 622-5 (e.g., a LUT). User activity/device information may include sensor information that may indicate user activities or device situations to include one of a user running or jogging with the device that includes apparatus 600, a user bike riding with the device, a user walking with the device, a user mountain climbing or hiking with the device, the device located in a high ambient noise environment, the device located in a public location, the device located in a public location or the device located in a work or office location.

According to some examples, apparatus 600 may also include an indication module 622-6. Indication module 622-6 may be executed by processor component to cause the device that includes apparatus 600 to indicate either the first media retrieval mode or the second media retrieval mode for retrieving the media content. For these examples, the device may indicate a given media retrieval mode via media retrieval mode indication 645 that may include at least one of an audio indication, a visual indication or a vibrating indication.

Various components of apparatus 600 and a device implementing apparatus 600 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware examples, a logic flow may be implemented or executed by computer executable instructions stored on at least one non-transitory computer readable medium or machine readable medium, such as an optical, magnetic or semiconductor storage. The examples are not limited in this context.

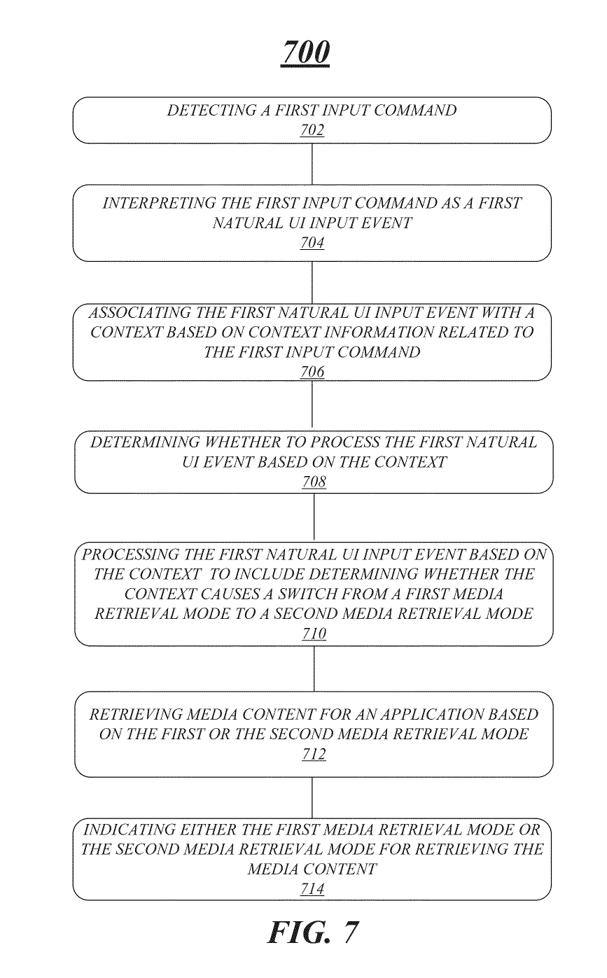

FIG. 7 illustrates an example of a logic flow 700. Logic flow 700 may be representative of some or all of the operations executed by one or more logic, features, or devices described herein, such as apparatus 600. More particularly, logic flow 700 may be implemented by gesture module 622-1, context association module 622-2, media mode selection module 622-3, media retrieval module 622-4, processing module 622-5 or indication module 622-6.

In the illustrated example shown in FIG. 7, logic flow 700 may include detecting a first input command at block 702. For these examples, input module 622-1 may receive input command information 605 that may include sensor information used to detect the first input command.

In some examples, logic flow 700 at block 704 may include interpreting the first input command as a first natural UI input event. For these examples, the device may be a device such as device 100 that may include an apparatus such as apparatus 600. Also, for these examples, input module 622-1 may interpret the first input command as the first natural UI input event based, at least in part, on received input command information 605.

According to some examples, logic flow 700 at block 706 may include associating the first natural UI input event with a context based on context information related to the first input command. For these examples, context association module 622-2 may associate the first natural UI input event with the context based on context information 615.

In some examples, logic flow 700 at block 708 may include determining whether to process the first natural UI event based on the context. For these examples, processing module 622-5 may determine that the context associated with the first natural UI event includes a user activity or device situation that results in ignoring or preventing media content retrieval by media retrieval module 622-4. For example, the first natural UI event is for changing music selections and was interpreted from an input command such as shaking the device. Yet the context includes a user running with the device so the first natural UI event may be ignored by preventing media retrieval module 622-4 from retrieving a new or different music selection.

According to some examples, logic flow 700 at block 710 may include processing the first natural UI input event based on the context to include determining whether the context causes a switch form a first media retrieval mode to a second media retrieval mode. For these examples, the context may not include a user activity or device situations that results in ignoring or preventing media content retrieval. In some examples, media mode selection module 622-3 may make the determination of whether to causes the switch in media retrieval mode based on the context associated with the first natural UI input event.

In some examples, logic flow at block 712 may include retrieving media content for an application based on the first or the second media retrieval mode. For these examples, media retrieval module 622-4 may retrieve media content 655 for the application from media content library 635.

According to some examples, logic flow at block 714 may include indicating either the first media retrieval mode or the second media retrieval mode for retrieving the media content. For these examples, indication module 622-6 may indicate either the first or second media retrieval mode via media retrieval mode indication 645 that may include at least one of an audio indication, a visual indication or a vibrating indication.

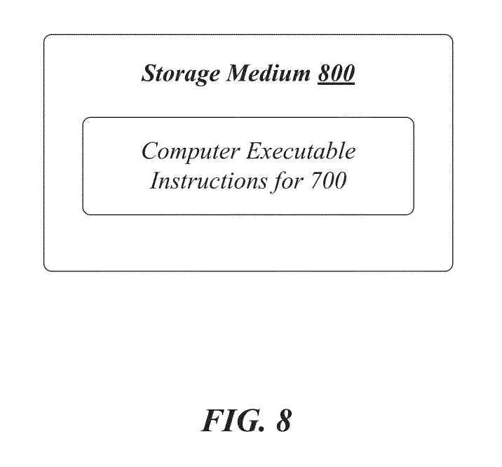

FIG. 8 illustrates an embodiment of a first storage medium. As shown in FIG. 8, the first storage medium includes a storage medium 800. Storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions to implement logic flow 700. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

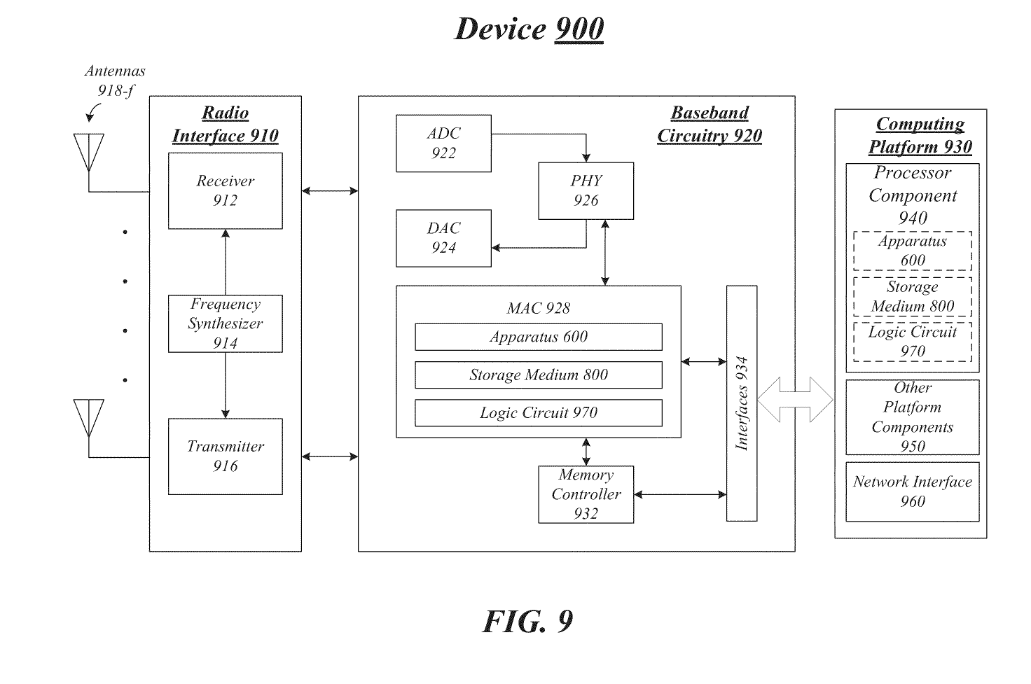

FIG. 9 illustrates an embodiment of a second device. As shown in FIG. 9, the second device includes a device 900. In some examples, device 900 may be configured or arranged for wireless communications in a wireless network and although not shown in FIG. 9, may also include at least some of the elements or features shown in FIG. 1 for device 100. Device 900 may implement, for example, apparatus 600, storage medium 800 and/or a logic circuit 970. The logic circuit 970 may include physical circuits to perform operations described for apparatus 600. As shown in FIG. 9, device 900 may include a radio interface 910, baseband circuitry 920, and computing platform 930, although examples are not limited to this configuration.

The device 900 may implement some or all of the structure and/or operations for apparatus 600, storage medium 700 and/or logic circuit 970 in a single computing entity, such as entirely within a single device. The embodiments are not limited in this context.

In one example, radio interface 910 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 910 may include, for example, a receiver 912, a transmitter 916 and/or a frequency synthesizer 914. Radio interface 910 may include bias controls, a crystal oscillator and/or one or more antennas 918-f. In another example, radio interface 910 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 920 may communicate with radio interface 910 to process receive and/or transmit signals and may include, for example, an analog-to-digital converter 922 for down converting received signals, a digital-to-analog converter 924 for up converting signals for transmission. Further, baseband circuitry 920 may include a baseband or physical layer (PHY) processing circuit 926 for PHY link layer processing of respective receive/transmit signals. Baseband circuitry 920 may include, for example, a MAC 928 for medium access control (MAC)/data link layer processing. Baseband circuitry 920 may include a memory controller 932 for communicating with MAC 928 and/or a computing platform 930, for example, via one or more interfaces 934.

In some embodiments, PHY processing circuit 926 may include a frame construction and/or detection module, in combination with additional circuitry such as a buffer memory, to construct and/or deconstruct communication frames (e.g., containing subframes). Alternatively or in addition, MAC 928 may share processing for certain of these functions or perform these processes independent of PHY processing circuit 926. In some embodiments, MAC and PHY processing may be integrated into a single circuit.

Computing platform 930 may provide computing functionality for device 900. As shown, computing platform 930 may include a processor component 940. In addition to, or alternatively of, baseband circuitry 920 of device 900 may execute processing operations or logic for apparatus 600, storage medium 800, and logic circuit 970 using the computing platform 930. Processor component 940 (and/or PHY 926 and/or MAC 928) may comprise various hardware elements, software elements, or a combination of both. Examples of hardware elements may include devices, logic devices, components, processors, microprocessors, circuits, processor components (e.g., processor component 620), circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Computing platform 930 may further include other platform components 950. Other platform components 950 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Computing platform 930 may further include a network interface 960. In some examples, network interface 960 may include logic and/or features to support network interfaces operated in compliance with one or more wireless broadband standards such as those described in or promulgated by the Institute of Electrical Engineers (IEEE). The wireless broadband standards may include Ethernet wireless standards (including progenies and variants) associated with the IEEE 802.11-2012 Standard for Information technology—Telecommunications and information exchange between systems—Local and metropolitan area networks—Specific requirements Part 11: WLAN Media Access Controller (MAC) and Physical Layer (PHY) Specifications, published March 2012, and/or later versions of this standard (“IEEE 802.11”). The wireless mobile broadband standards may also include one or more 3G or 4G wireless standards, revisions, progeny and variants. Examples of wireless mobile broadband standards may include without limitation any of the IEEE 802.16m and 802.16p standards, 3GPP Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1xRTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP before Release 8 (“3G 3GPP”) or Release 8 and above (“4G 3GPP”) of LTE/System Architecture Evolution (SAE), and so forth. The examples are not limited in this context.

Device 900 may include, but is not limited to, user equipment, a computer, a personal computer (PC), a desktop computer, a laptop computer, a notebook computer, a netbook computer, a tablet, a smart phone, embedded electronics, a gaming console, a network appliance, a web appliance, or combination thereof. Accordingly, functions and/or specific configurations of device 900 described herein, may be included or omitted in various examples of device 900, as suitably desired. In some examples, device 900 may be configured to be compatible with protocols and frequencies associated with IEEE 802.11, 3G GPP or 4G 3GPP standards, although the examples are not limited in this respect.

Embodiments of device 900 may be implemented using single input single output (SISO) architectures. However, certain implementations may include multiple antennas (e.g., antennas 918-f) for transmission and/or reception using adaptive antenna techniques for beamforming or spatial division multiple access (SDMA) and/or using multiple input multiple output (MIMO) communication techniques.

The components and features of device 900 may be implemented using any combination of discrete circuitry, application specific integrated circuits (ASICs), logic gates and/or single chip architectures. Further, the features of device 900 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that device 900 shown in the block diagram of FIG. 9 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in examples.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled”, “connected”, or “capable of being coupled” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In some examples, an example apparatus for a device may include a processor component. For these examples, the apparatus may also include an input module for execution by the processor component that may receive sensor information that indicates an input command and interprets the input command as a natural UI input event. The apparatus may also include a context association module for execution by the processor component that may associate the natural UI input event with a context based on context information related to the input command. The apparatus may also include a media mode selection module for execution by the processor component that may determine whether the context causes a switch from a first media retrieval mode to a second media retrieval mode. The apparatus may also include a media retrieval module for execution by the processor component that may retrieve media content for an application responsive to the natural UI input event based on the first or the second media retrieval mode.

According to some examples, the example apparatus may also include a processing module for execution by the processor component to prevent the media retrieval module from retrieving media content for the application based on the natural UI input event associated with the context. For these examples, the content may include one of running or jogging with the device, bike riding with the device, walking with the device, mountain climbing or hiking with the device, the device located in a high ambient noise environment, the device located in a public location or the device located in a work or office location.

In some examples for the example apparatus, the first media retrieval mode may be based on a first media mapping that maps first media content to the natural UI input event when associated with the context. For these examples, the media retrieval module may retrieve media content that includes at least one of a first emoticon, a first animation, a first video, a first music selection, a first voice recording, a first sound effect or a first image.

According to some examples for the example apparatus, the second media retrieval mode may be based on a second media mapping that maps second media content to the natural UI input event when associated with the context. For these examples, the media retrieval module may retrieve media content that includes at least one of a second emoticon, a second animation, a second video, a second music selection, a second voice recording, a second sound effect or a second image.

In some examples, the example apparatus may also include an indication module for execution by the processor component to cause the device to indicate either the first media retrieval mode or the second media retrieval mode for retrieving the media content. For these examples, the device may indicate a given media retrieval mode via at least one of an audio indication, a visual indication or a vibrating indication.

According to some examples for the example apparatus, the media retrieval module may retrieve the media content from at least one of a media content library maintained at the device, a network accessible media content library maintained remote to the device or user-generated media content generated contemporaneously with the input command.

In some examples for the example apparatus, the input command may include one of a touch gesture, an air gesture, a device gesture that includes purposeful movement of at least a portion of the device, an audio command, an image recognition or a pattern recognition.

According to some examples for the example apparatus, the sensor information received by the input module that indicates the input command may include one of touch screen sensor information detecting the touch gesture to a touch screen of the device, image tracking information detecting the air gesture in a given air space near one or more cameras for the device, motion sensor information detecting the purposeful movement of at least the portion of the device, audio information detecting the audio command or image recognition information detecting the image recognition via one or more cameras for the device or pattern recognition information detecting the pattern recognition via one or more cameras for the device.

In some examples for the example apparatus, the context information related to the input command may include one or more of a time of day, GPS information for the device, device orientation information, device rate of movement information, image or object recognition information, the application executing on the device, an intended recipient of the media content for the application, user inputted information to indicate a type of user activity for the input command, user biometric information or ambient environment sensor information at the device to include noise level, air temperature, light intensity, barometric pressure or elevation.

According to some examples for the example apparatus, the application to include one of a text messaging application, a video chat application, an e-mail application, a video player application, a game application, a work productivity application, an image capture application, a web browser application, a social media application or a music player application.

In some examples for the example apparatus, if the application includes one of the text messaging application, the video chat application, the e-mail application or the social media application, the context information may also include an identity for a recipient of a message generated by the type of application responsive to the natural UI input event. For these examples, a profile with identity and relationship information may be associated with the recipient identity. The relationship information may indicate that a message sender and the message recipient have a defined relationship.

According to some examples, the example apparatus may also include a memory that has at least one of volatile memory or non-volatile memory. For these examples, the memory may be capable of at least temporarily storing media content retrieved by the media retrieval module for the application executing on the device responsive to the natural UI input event based on the first or the second media retrieval mode.

In some examples, example methods implemented at a device may include detecting a first input command. The example methods may also include interpreting the first input command as a first natural user interface (UI) input event and associating the first natural UI input event with a context based on context information related to the input command. The example methods may also include determining whether to process the first natural UI input event based on the context.

According to some examples, the example methods may also include processing the first natural UI input event based on the context. Processing may include determining whether the context causes a switch from a first media retrieval mode to a second media retrieval mode and then retrieving media content for an application based on the first or the second media retrieval mode.

In some examples for the example methods, the first media retrieval mode may be based on a first media mapping that maps first media content to the first natural UI input event when associated with the context. For these examples, the media content retrieved to include at least one of a first emoticon, a first animation, a first video, a first music selection, a first voice recording, a first sound effect or a first image.

According to some examples for the example methods, the second media retrieval mode may be based on a second media mapping that maps second media content to the first natural UI input event when associated with the context. For these examples, the media content retrieved may include at least one of a second emoticon, a second animation, a second video, a second music selection, a second voice recording, a second sound effect or a second image.

In some examples, the example methods may include indicating, by the device, either the first media retrieval mode or the second media retrieval mode for retrieving the media content via at least one of an audio indication, a visual indication or a vibrating indication.

According to some examples for the example methods, the media content may be retrieved from at least one of a media content library maintained at the device, a network accessible media content library maintained remote to the device or user-generated media content generated contemporaneously with the input command.

In some examples for the example methods, the first input command may include one of a touch gesture, an air gesture, a device gesture that includes purposeful movement of at least a portion of the device, an audio command, an image recognition or a pattern recognition.

According to some examples for the example methods, the first natural UI input event may include one of a touch gesture to a touch screen of the device, a spatial gesture in the air towards one or more cameras for the device, a purposeful movement detected by motion sensors for the device, audio information detected by a microphone for the device, image recognition detected by one or more cameras for the device or pattern recognition detected by one or more cameras for the device.

In some examples for the example methods, the detected first user gesture may activate a microphone for the device and the first user gesture interpreted as the first natural UI input event based on a user generated audio command detected by the microphone.

According to some examples for the example methods, the detected first input command may activate a microphone for the device and the first input command interpreted as the first natural UI input event based on a user generated audio command detected by the microphone.

In some examples for the example methods, the context information related to the first input command may include one or more of a time of day, GPS information for the device, device orientation information, device rate of movement information, image or object recognition information, the application executing on the device, an intended recipient of the media content for the application, user inputted information to indicate a type of user activity for the first input command, user biometric information or ambient environment sensor information at the device to include noise level, air temperature, light intensity, barometric pressure or elevation.

According to some examples for the example methods, the context may include one of running or jogging with the device, bike riding with the device, walking with the device, mountain climbing or hiking with the device, the device located in a high ambient noise environment, the device located in a public location, the device located in a private or home location or the device located in a work or office location.

In some examples for the example methods, the application may include one of a text messaging application, a video chat application, an e-mail application, a video player application, a game application, a work productivity application, an image capture application, a web browser application, a social media application or a music player application.

According to some examples for the example methods, the application may include one of the text messaging application, the video chat application, the e-mail application or the social media application and the context information to also include an identity for a recipient of a message generated by the type of application responsive to the first natural UI input event. For these examples, a profile with identity and relationship information may be associated with the recipient identity. The relationship information may indicate that a message sender and the message recipient have a defined relationship.

In some examples, at least one machine readable medium comprising a plurality of instructions that in response to being executed on a system at a device may cause the system to detect a first input command. The instructions may also cause the system to detect a first input command and interpret the first input command as a first natural UI input event. The instructions may also cause the system to associate the first natural UI input event with a context based on context information related to the input command. The instructions may also cause the system to determine whether to process the first natural UI input event based on the context. The instructions may also cause the system to process the first natural UI input event by determining whether the context causes a switch from a first media retrieval mode to a second media retrieval mode and retrieve media content for an application based on the first or the second media retrieval mode.

According to some examples for the at least one machine readable medium, the first media retrieval mode may be based on a media mapping that maps first media content to the first natural UI input event when associated with the context. For these examples, the media content retrieved may include at least one of a first emoticon, a first animation, a first video, a first music selection, a first voice recording, a first sound effect or a first image.

In some examples for the at least one machine readable medium, the second media retrieval mode may be based on a media mapping that maps second media content to the first natural UI input event when associated with the context. For these examples, the media content retrieved may include at least one of a second emoticon, a second animation, a second video, a second music selection, a second voice recording, a second sound effect or a second image.

According to some examples for the at least one machine readable medium, the instructions may also cause the system to retrieve the media content from at least one of a media content library maintained at the device, a network accessible media content library maintained remote to the device or user-generated media content generated contemporaneously with the input command.

In some examples for the at least one machine readable medium, the first input command may include one of a touch gesture, an air gesture, a device gesture that includes purposeful movement of at least a portion of the device, an audio command, an image recognition or a pattern recognition.

According some examples for the at least one machine readable medium, the first natural UI input event may include one of a touch gesture to a touch screen of the device, a spatial gesture in the air towards one or more cameras for the device or a purposeful movement detected by motion sensors for the device, audio information detected by a microphone for the device, image recognition detected by one or more cameras for the device or pattern recognition detected by one or more cameras for the device.

In some examples for the at least one machine readable medium, the context information related to the input command may include one or more of a time of day, GPS information for the device, device orientation information, device rate of movement information, image or object recognition information, the application executing on the device, an intended recipient of the media content for the application, user inputted information to indicate a type of user activity for the input command, user biometric information or ambient environment sensor information at the device to include noise level, temperature, light intensity, barometric pressure, or elevation.

According to some examples for the at least one machine readable medium, the context may include one of a running or jogging with the device, bike riding with the device, walking with the device, mountain climbing or hiking with the device, the device located in a high ambient noise environment, the device located in a public location, the device located in a private or home location or the device located in a work or office location.

In some examples for the at least one machine readable medium, the context information related to the input command may include a type of application for the application to include one of a text messaging application, a video chat application, an e-mail application or a social media application and the context information related to the input command to also include an identity for a recipient of a message generated by the type of application responsive to the first natural UI input event. For these examples, a profile with identity and relationship information may be associated with the recipient identity. The relationship information may indicate that a message sender and the message recipient have a defined relationship.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1-25. (canceled)

26. An apparatus comprising:
a processor component for a device;
an input module for execution by the processor component to receive sensor information that indicates an input command and interprets the input command as a natural user interface (UI) input event;
a context association module for execution by the processor component to associate the natural UI input event with a context based on context information related to the input command;
a media mode selection module for execution by the processor component to determine whether the context causes a switch from a first media retrieval mode to a second media retrieval mode; and
a media retrieval module for execution by the processor component to retrieve media content for an application responsive to the natural UI input event based on the first or the second media retrieval mode.

27. The apparatus of claim 26, comprising:
a processing module for execution by the processor component to prevent the media retrieval module from retrieving media content for the application based on the natural UI input event associated with the context that includes one of running or jogging with the device, bike riding with the device, walking with the device, mountain climbing or hiking with the device, the device located in a high ambient noise environment, the device located in a public location or the device located in a work or office location.

28. The apparatus of claim 26, comprising the first media retrieval mode is based on a media mapping that maps first media content to the natural UI input event when associated with the context, the second media retrieval mode is based on a media mapping that maps second media content to the first natural UI input event when associated with the context, the media retrieval module to retrieve media content based on the first or the second media retrieval mode that includes at least one of a first emoticon, a first animation, a first video, a first music selection, a first voice recording, a first sound effect or a first image.

29. The apparatus of claim 26, comprising:
an indication module for execution by the processor component to cause the device to indicate either the first media retrieval mode or the second media retrieval mode for retrieving the media content, the device to indicate a given media retrieval mode via at least one of an audio indication, a visual indication or a vibrating indication.

30. The apparatus of claim 26, comprising the media retrieval module to retrieve the media content from at least one of a media content library maintained at the device, a network accessible media content library maintained remote to the device or user-generated media content generated contemporaneously with the input command.

31. The apparatus of claim 26, the input command comprising one of a touch gesture, an air gesture, a device gesture that includes purposeful movement of at least a portion of the device, an audio command, an image recognition or a pattern recognition.

32. The apparatus of claim 26, comprising the sensor information received by the input module that indicates the input command includes one of touch screen sensor information detecting the touch gesture to a touch screen of the device, image tracking information detecting the air gesture in a given air space near one or more cameras for the device, motion sensor information detecting the purposeful movement of at least the portion of the device, audio information detecting the audio command or image recognition information detecting the image recognition via one or more cameras for the device or pattern recognition information detecting the pattern recognition via one or more cameras for the device.

33. The apparatus of claim 26, the context information related to the input command comprises one or more of a time of day, global positioning system (GPS) information for the device, device orientation information, device rate of movement information, image or object recognition information, the application executing on the device, an intended recipient of the media content for the application, user inputted information to indicate a type of user activity for the input command, user biometric information or ambient environment sensor information at the device to include noise level, air temperature, light intensity, barometric pressure or elevation.

34. The apparatus of claim 26, comprising the application to include one of a text messaging application, a video chat application, an e-mail application, a video player application, a game application, a work productivity application, an image capture application, a web browser application, a social media application or a music player application.

35. The apparatus of claim 34, the application comprises one of the text messaging application, the video chat application, the e-mail application or the social media application and the context information to also include an identity for a recipient of a message generated by the type of application responsive to the natural UI input event.

36. The apparatus of claim 35, comprising a profile with identity and relationship information, the relationship information to indicate that a message sender and the message recipient have a defined relationship.

37. The apparatus of claim 26 comprising:
a memory to include at least one of volatile memory or non-volatile memory, the memory capable of at least temporarily storing media content retrieved by the media retrieval module for the application executing on the device responsive to the natural UI input event based on the first or the second media retrieval mode.

38. A method comprising:
detecting, at a device, a first input command;
interpreting the first input command as a first natural user interface (UI) input event;
associating the first natural UI input event with a context based on context information related to the input command; and
determining whether to process the first natural UI input event based on the context.

39. The method of claim 38, comprising:
processing the first natural UI input event based on the context to include determining whether the context causes a switch from a first media retrieval mode to a second media retrieval mode; and
retrieving media content for an application based on the first or the second media retrieval mode.

40. The method of claim 39, comprising the first media retrieval mode is based on a media mapping that maps first media content to the first natural UI input event when associated with the context, the second media retrieval mode is based on a media mapping that maps second media content to the first natural UI input event when associated with the context, the media content retrieved based on the first or the second media retrieval mode to include at least one of a first emoticon, a first animation, a first video, a first music selection, a first voice recording, a first sound effect or a first image.

41. The method of claim 38, the first input command comprising one of a touch gesture, an air gesture, a device gesture that includes purposeful movement of at least a portion of the device, an audio command, an image recognition or a pattern recognition.

42. The method of claim 41, the first natural UI input event comprising one of a touch gesture to a touch screen of the device, a spatial gesture in the air towards one or more cameras for the device, a purposeful movement detected by motion sensors for the device, audio information detected by a microphone for the device, image recognition detected by one or more cameras for the device or pattern recognition detected by one or more cameras for the device.

43. The method of claim 41, comprising the detected first input command to activate a microphone for the device and the first input command interpreted as the first natural UI input event based on a user generated audio command detected by the microphone.

44. The method of claim 41, comprising the detected first input command to activate a camera for the device and the first input command interpreted as the first natural UI input event based on an object or pattern recognition detected by the camera.

45. The method of claim 38, the context comprising one of running or jogging with the device, bike riding with the device, walking with the device, mountain climbing or hiking with the device, the device located in a high ambient noise environment, the device located in a public location, the device located in a private or home location or the device located in a work or office location.

46. At least one machine readable medium comprising a plurality of instructions that in response to being executed on a system at a device cause the system to:
detect a first input command;
interpret the first input command as a first natural user interface (UI) input event;
associate the first natural UI input event with a context based on context information related to the input command;
determine whether to process the first natural UI input event based on the context;
process the first natural UI input event by determining whether the context causes a switch from a first media retrieval mode to a second media retrieval mode; and
retrieve media content for an application based on the first or the second media retrieval mode.

47. The at least one machine readable medium of claim 46, comprising the first media retrieval mode is based on a media mapping that maps first media content to the first natural UI input event when associated with the context, the second media retrieval mode is based on a media mapping that maps second media content to the first natural UI input event when associated with the context, the media content retrieved based on the first or the second media retrieval mode to include at least one of a first emoticon, a first animation, a first video, a first music selection, a first voice recording, a first sound effect or a first image.

48. The at least one machine readable medium of claim 46, the first input command comprising one of a touch gesture, an air gesture, a device gesture that includes purposeful movement of at least a portion of the device, an audio command, an image recognition or a pattern recognition.

49. The at least one machine readable medium of claim 48, the first natural UI input event comprising one of a touch gesture to a touch screen of the device, a spatial gesture in the air towards one or more cameras for the device or a purposeful movement detected by motion sensors for the device, audio information detected by a microphone for the device, image recognition detected by one or more cameras for the device or pattern recognition detected by one or more cameras for the device.

50. The at least one machine readable medium of claim 46, the context information related to the input command comprises one or more of a time of day, global positioning system (GPS) information for the device, device orientation information, device rate of movement information, image or object recognition information, the application executing on the device, an intended recipient of the media content for the application, user inputted information to indicate a type of user activity for the input command, user biometric information or ambient environment sensor information at the device to include noise level, temperature, light intensity, barometric pressure, or elevation.
